(19) United States
(12) Patent Application Publication
(10) Pub. No.: US 2023/0165188 A1
(43) Pub. Date: Jun. 1, 2023

(54) METHOD AND APPLIANCE FOR LAWN CARE WITH LANE RECOGNITION

(71) Applicant: Wiedenmann GmbH, Rammingen, DE (US)

(72) Inventors: Thomas JUNGINGER, Blaustein-Bermaringen (DE); Volker ZIPPEL, Holldorf (DE); Ralph WIEDENMANN, Herbrechtingen (DE); Andreas JUNGINGER, Asselfingen (DE); Martin WINKLER, Ulm (DE); Sebastian HOLZBERGER, Niederstoltzingen (DE); Karin WÖRZ, Weidenstetten (DE); Uwe WIEDENMANN, Rammingen (DE)

(21) Appl. No.: 18/072,123

(22) Filed: Nov. 30, 2022

(30) Foreign Application Priority Data
Dec. 1, 2021 (DE) 10 2021 131 679.0
Dec. 1, 2021 (DE) 10 2021 131 681.2
Dec. 1, 2021 (DE) 10 2021 131 682.0
Dec. 16, 2021 (DE) 10 2021 133 545.0
Jan. 11, 2022 (DE) 10 2022 100 541.0

(51) Int. Cl. A01D 34/00; A01B 45/02; G05D 1/02; G05D 1/00

(52) U.S. Cl. CPC A01D 34/008; A01B 45/023; G05D 1/0219; G05D 1/0234; G05D 1/0246; G05D 1/0038

(57) ABSTRACT

A self-propelled lawn care appliance for aerating and subsoiling the ground below a turf includes a chassis, an implement with piercing tools movable up and down for piercing the ground for subsoiling, and an optical lane recognition device comprising at least one camera and an image processing unit. In a first mode of operation of the lawn care appliance, the lane recognition device is designed to recognize a hole pattern of an area of the ground previously treated by the lawn care appliance and, based thereon, a boundary of a previously treated lane. In a second mode of operation of the lawn care appliance, the lane recognition device is designed to recognize a defined boundary of the deposited soil material of a ground area previously treated by the lawn care appliance and, based thereon, the boundary of a previously treated lane.

### CROSS-REFERENCE TO RELATED APPLICATIONS

This application claims priority from German Application No. DE 10 2021 131 682.0 filed Dec. 1, 2021; German Application No. DE 10 2021 131 681.2 filed Dec. 1, 2021; German Application No. DE 10 2021 131 679.0 filed Dec. 1, 2021; German Application No. DE 10 2021 133 545.0 filed Dec. 16, 2021; and German Application No. DE 10 2022 100 541.0 filed Jan. 11, 2022. The aforementioned applications are incorporated herein by reference in their entireties.

### TECHNICAL FIELD

The invention relates to a self-propelled lawn care appliance for aerating or subsoiling the ground beneath a turf, comprising: a chassis with at least one drive shaft and a steering device, and an implement comprising a row of piercing tools that extends over a lane width, the piercing tools having tines movable up and down for piercing the ground for subsoiling. Further, the invention relates to a lawn care method for aerating or subsoiling the ground below the turf while moving a lawn care appliance across a lane on the ground and piercing, pivoting and extracting piercing tools.

### RELATED ART

For the technological background, reference is made to the following literature:
[1] DE 10 2018 114 882 A1
[2] U.S. Pat. No. 7,096,969 B2
[3] DE 10 2014 104 876 A1
[4] DE 10 2008 017 242 A1
[5] DE 10 2005 055 289 B3
[6] DE 10 2005 021 025 A1
[7] DE 10 2004 018 591 A1
[8] Computer Vision—Wikipedia, downloaded from https://de.wikipedia.org/wiki/Computer_Vision on 29 Nov. 2021
[9] Bildverarbeitungssysteme|STEMMER IMAGING, downloaded from https://www.stemmer-imaging.com/de-ch/produkte/kategorie/systeme on 29 Nov. 2021
[10] DE 10 2015 116 574 A1
[11] DE 10 2017 122 710 A1
[12] EP 3 494 770 B1
[13] US 2015/0321694 A1
[14] EP 3 300 579 B1
[15] EP 3 165 062 A1
[16] EP 2 954 772 A1
[17] EP 2 220 926 A1
[18] EP 1 762 129 A1
[19] DE 24 55 836 B2
[20] AU 2015 347 785 B2
[21] U.S. Pat. No. 10,813,267 B2
[22] EP 3 685 649 A1
[23] EP 2 316 259 B1
[24] EP 1 266 554 A2
[25] DE 10 2017 217 391 A1
[26] DE 197 43 884 A1
[27] DE 10 2019 203 651 A1
[28] DE 10 2017 130 694 A1

Nowadays, implements of lawn care appliances disclosed in literature [1] to [7] are usually articulated to tractors or similar towing vehicles on a wishbone. As smaller implements, there are also specialized implements with a seat, similar to a ride-on mower, and implements with a handlebar for a person to walk along. Due to the mode of operation of the lawn care appliances, corresponding lawn care methods for ground aeration or subsoiling of ground are also known.

Literature [8] and [9] relates to systems for image capture and pattern recognition that can be used in industrial production or in the field of drive assist systems for motor vehicles.

Literature [10] to [24] relates to self-propelled harvesters and drive assist systems therefor, in which steering is assisted or performed by the detection of the quantity of harvest directly ahead of the machine, or positioning in the field is performed by other means such as GPS or laser. All these systems are either unsuitable or too inaccurate for lawn care equipment or too complex and correspondingly expensive.

Literature [25] relates to an agricultural working vehicle in the form of a tractor equipped with a plow and having a lane guidance system comprising at least one optical image capturing device arranged on the working vehicle and an image processing system, wherein reference objects such as plant rows or working edges located along a lane travelled by the working vehicle can be detected by the at least one image capturing device and can be discerned by means of the image processing system, and wherein a lane can be predetermined by a control device on the basis of an evaluation of the plant rows or working edges. Also in literature [26], a tractor with plow is provided, wherein working edges of the plow are used for lane recognition. Also in literature [27] as well as literature [28], rows of plants or existing ground structures are used as reference objects for steering a tractor. Accordingly, the systems known from [25] to [28] only work if corresponding reference objects are present beforehand, which is not the case for ground aeration and subsoiling. In particular, in the usual different modes of a ground aerator or subsoiling device for lawns, no such reference objects are present, and if the ground were dug up as in the case of a plow or the like to create a visually discernible working edge, the lawn would be destroyed, which would be contrary to the purpose of a lawn care appliance.

### SUMMARY

The invention is based on the problem of improving a self-propelled lawn care appliance with respect to operability while keeping its construction as inexpensive as possible. In addition, the aim is to provide a lawn care method for ground aeration or subsoiling that can be carried out particularly easily and inexpensively by an operator.

To solve the problem, the invention provides a lawn care appliance as well as a lawn care method according to the independent claims.

Advantageous embodiments are the subject of the dependent claims.

According to one aspect thereof, the invention provides a self-propelled lawn care appliance for ground aeration or subsoiling of ground below the turf, comprising: a chassis with at least one drive shaft and a steering device; and an implement comprising a row of piercing tools that extends over a lane width, the piercing tools having tines movable up and down for piercing the ground for subsoiling, characterized by an optical lane recognition device having at least one camera for capturing an image of an area of the ground laterally of the implement with respect to the direction of travel, and an image processing unit for image processing of and pattern recognition in images captured by the at least one camera,

a) wherein in a first mode of operation of the lawn care appliance, the implement is designed to create a hole pattern with a predefined lane width when travelling across the ground during the use of the implement, and the lane recognition device is designed to recognize the hole pattern of an area of the ground previously treated by the lawn care appliance and, based thereon, a boundary of a previously treated lane, and/or

b) wherein in a second mode of operation of the lawn care appliance, the implement is designed to remove soil material from the ground and deposit it on the predefined lane width with a defined boundary, wherein the lane recognition device is designed to recognize the defined boundary of the deposited soil material of a ground area previously treated by the lawn care appliance and, based thereon, the boundary of a previously treated lane.

It is preferred that, in a third mode of operation of the lawn care appliance, the implement is designed to generate, by means of a supporting or engaging element engaging the ground, a ground pattern having a defined boundary of the lane width, the lane recognition device being designed to recognize, on the basis of the defined boundary of the ground pattern, a previously treated lane.

Preferably, the camera is arranged and configured to capture an image of the lateral area with respect to the direction of travel that is located in front of the implement in the direction of travel. For example, an image is captured of an area that is located to the side of the chassis with the implement being arranged at the rear area.

It is preferred that a controller is provided for controlling the drive shaft and the steering device, which is adapted in an automatic mode to steer the lawn care appliance based on the output of the lane recognition device such that the current lane of the implement extends immediately adjacent to the previously treated lane.

It is preferred that the lawn care appliance is remotely controllable and a user interface is formed on a remote control of the lawn care appliance.

It is preferred that the user interface is provided with a display on which information about a target lane determined based on the data from the lane recognition device and information about a current actual lane are displayed.

It is preferred that the camera of the lane recognition device is arranged on the side of the lawn care appliance.

It is preferred that the lane recognition device has at least one camera on each of the two sides.

It is preferred that the drive shaft comprises two differently controllable and drivable drive wheels and that the chassis further comprises at least one freely rotatable swivel wheel arranged at a distance from the drive shaft in the direction of travel.

It is preferred that, in the first mode of operation, solid tines are provided on the piercing tools and/or that, in the second mode of operation, hollow tines are provided on the piercing tools.

It is preferred that at least one mechanical guiding and/or marking element is provided for generating the visually discernible defined boundary of the previously treated lane.

It is preferred that the at least one mechanical guiding and/or marking element comprises a swath board or a swath plate or a tracking disc for engaging the ground.

According to another aspect, the invention provides a lawn care method for ground aeration or subsoiling of the ground below a turf, comprising:

moving a lawn care appliance along a first lane across the ground and treating the ground by alternately inserting and extracting a series of piercing tools with tines of the lawn care appliance while pivoting the piercing tools in the ground, thereby creating a visually recognizable pattern to determine a boundary of the first lane, moving the lawn care appliance along a second lane adjacent to and in parallel with the first lane to correspondingly treat the ground along the second lane, wherein the first lane is detected by optically detecting the recognizable pattern to discern the boundary of the first lane and steer the lawn care appliance in response to the detected boundary.

Preferably, the lawn care method comprises remotely operating the lawn care appliance by an operator who is a distance from the lawn care appliance.

Preferably, the pattern recognition comprises:

detecting a pattern of holes on the ground produced by the piercing tools.

Preferably, the pattern recognition comprises:

generating a defined optically detectable boundary of the first lane by at least one mechanical guiding and marking element, and optically detecting the boundary of the first lane.

Preferably, the step of generating the defined boundary comprises:

depositing soil material removed from the ground during piercing and extraction of the piercing tools, and arranging the deposited soil material on the first lane up to the defined boundary.

A preferred embodiment of the invention provides for a remotely operable lawn care appliance. This eliminates the need for the operator to be at a handlebar or on a seat at a specific location on the lawn care appliance and allows the operator to position himself to have the best view of the implement. However, remotely steering a lawn care appliance following a previously treated lane is difficult. Advantageous embodiments of the invention assist an operator in this task.

Advantageous embodiments of the invention provide a lawn care appliance with an optical lane connection system.

Manual connective driving precisely within the lane is very demanding for the operator, especially with a radio remote control.

GNSS-based automatic positioning on golf courses and in stadiums is only partially applicable due to shading and therefore too inaccurate. Also the other positioning and driving assistance systems known from literature [10]-[24] are either unsuitable for ground aerators or too expensive and especially too demanding to operate.

In advantageous embodiments of the invention, on the other hand, it is provided that the ground image of a reference lane produced by the working process is captured by a camera and evaluated by image recognition software.

Preferably, the geometry pattern produced by the working process is recognized by means of image recognition software and an ideal connecting lane is determined, preferably via an adjustable offset value.

Preferably, the steering of the vehicle is controlled by an actuator in such a way that a specific reference point of the machine is located on the connecting lane.

Preferably, steering commands are triggered to the traction drive on the basis of the comparison of the camera position with the lane position.

Preferably, additional attachments of the machine, such as swath plates, rollers, tracking discs, generate certain features for image recognition on the reference lane.

In one mode of operation, the geometry pattern to be recognized is the hole pattern produced by the working process. In particular, the set hole spacing is taken into account for pattern recognition.

Preferably, the optical image recognition system is programmed for different optical features. Depending on the individual case—mode of operation—the user can change the connection recognition.

Preferably, a live camera image shows the user the thus recognized or discerned connection line and the currently existing lane.

Preferably, the image quality of the camera images is enhanced in low light ambient conditions by the use of additional light sources arranged on the lawn care machine.

Preferred embodiments of the invention have the advantage of providing a more uniform treatment with substantially simplified operation.

When operating with Vollspoon and a high growth height, for example, a rolled grass edge can be recognized as an image feature.

When operating with hollow spoons (hollow tines), a boundary of a depositing area of deposited cones of soil material produced by a swath plate or similar guiding element can be used as an image feature.

Preferably, the ground image of a reference lane produced by the work process is thus treated by mechanical elements (swath plates, tracking discs) in such a way that a lane image is produced which can be evaluated by a camera system. Based on the comparison of the camera position with the lane position, steering commands are triggered to the traction drive.

### BRIEF DESCRIPTION OF THE DRAWINGS

One exemplary embodiment will be explained in more detail below with reference to the accompanying drawings. In the drawings it is shown by:

FIG. 1 a top view of a preferred embodiment of a lawn care appliance in a working mode according to a first mode of operation;

FIG. 2 a top view similar to FIG. 1, wherein the lawn care appliance is operated in a second mode of operation;

FIG. 3 a perspective view of the lawn care appliance in operation according to the second mode of operation, together with a remote control of the lawn care appliance;

FIG. 4 an enlarged view of an embodiment of the remote control.

### DETAILED DESCRIPTION

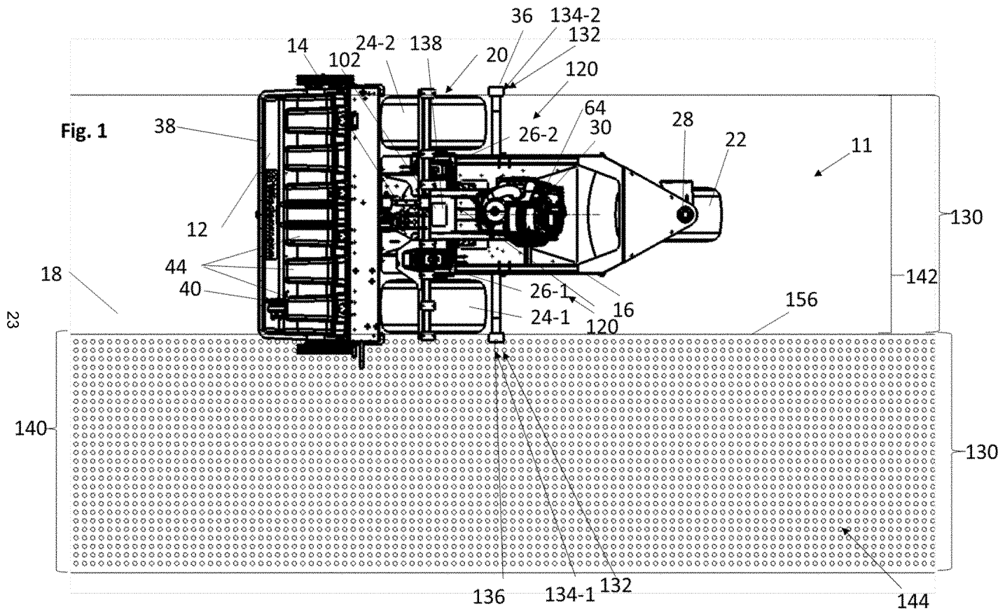

FIGS. 1 to 3 show a preferred embodiment of a lawn care appliance 11 in different modes of operation. The lawn care appliance 11 comprises an implement 12, which is articulated to a chassis 16 by means of an implement linkage 14 so as to be vertically movable relative to the chassis 16. By means of a lifting actuator not shown in more detail in the Figures, the implement linkage 14 and thus the implement 12 can be raised relative to the chassis 16 in a transport mode and lowered for contacting the ground 18 in a work mode shown in the Figures.

The chassis 16 comprises a drive shaft 20 and at least one swivel wheel 22 spaced from the drive shaft 20. Further, the lawn care appliance 10 is provided with a steering device 120.

In the illustrated embodiment, the drive shaft 20 comprises a first drive wheel 24-1 on one side of the lawn care appliance 11 and a second drive wheel 24-2 on the other side of the lawn care appliance 11. Each of the drive wheels 24-1, 24-2 is drivable differently by its own drive motor 26-1, 26-2. The steering device 120 has a steering control unit as part of the controller 102 of the lawn care appliance 11, by means of which the drive motors 26-1, 26-2 can be controlled, so that cornering is made possible by different drive speeds of the drive wheels 24-1, 24-2, and turning of the lawn care appliance 11 is also made possible by different drive directions. The swivel wheel 22 can be swiveled accordingly about a swivel axis 28 extending vertically with at least one directional component, in order to support the front area of the lawn care appliance 11 and thereby follow the steering movements.

The implement 12, since most of the energy is required for this purpose, is directly driven by a drive unit 30 which also provides the energy for the drive motors 26-1, 26-2. In a preferred embodiment, the drive unit 30 comprises an internal combustion engine 64. In one possible embodiment, the drive motors 26-1, 26-2 are hydraulically driven, with the internal combustion engine 64 also driving a hydraulic pump to supply hydraulic pressure. In the preferred embodiment, the drive motors 26-1, 26-2 are electric motors, with the internal combustion engine 64 supplying the electric power via a generator. Of course, other drive units 30 are also possible, such as a battery-electric motor combination or the like.

The implement 12 is designed as a subsoiling device 38, as known for example from literature [1]-[7]. Reference is made to [1]-[7] for more details on the possible design of the subsoiling device.

Accordingly, the implement 12 includes a series of piercing tools 40 with tines 42 that are movable up and down on support arms 44. In the position supported on the ground, the tines 42 of the piercing tools are thereby pierced into the ground when the respective support arm 44 is moved downwards, pivoted there somewhat in order to loosen the ground below the turf, and then pulled out of the ground again when the support arm 44 is moved upwards.

In embodiments not shown in more detail, the lawn care appliance 11 may be formed as described and shown in literature [1], with an operator seat and with an operator interface that is arranged, for example, on the chassis 16 together with a driver's cab, or it may be designed as described and shown in literature [2], comprising a handle such as a handlebar, a steering handle or the like having the operator interface for an operator to walk along.

In the preferred embodiment of the lawn care appliance 11 shown, the lawn care appliance 11 is designed to be remotely operated by an operator who can also stand or walk at a certain distance from the lawn care appliance 11. For this purpose, the lawn care appliance 11 has a remote control 122 in communication with the controller 102 via a bidirectional radio link, on which an operator interface 124 is provided with a display 126 and with actuating elements 128.

For example, the actuating elements 128 can be used to control forward travel, reverse travel, and the steering device 120. In addition, actuating elements 128 are provided for operating further actuators of the lawn care appliance 11 and for setting different modes and modes of operation of the lawn care appliance 11. The display 126 is designed, for example, as a display via which different information about the state and operation of the lawn care appliance 11 can be displayed.

In order to achieve the most uniform growth of lawns, for example on golf courses or in soccer stadiums or in parks, lawn care should be carried out as uniformly as possible. When driving across a lane, the ground 18 is treated with a working width of the implement 12 over which the tines 42 of the piercing tools 40 are distributed. This working width of the implement 12 is referred to herein as the width of a lane or lane width 130. If a larger area is to be treated, it is advantageous if the individual lanes 140, 142 are directly adjacent to one another, i.e., if possible, without spacing between the lanes 140, 142 and also without overlapping between the lanes. For this purpose, with the conventional lawn care appliances of literature [1]-[7], the operator had to control the lawn care appliance 11 as precisely as possible.

To assist the operator, an optical lane recognition device 132 is provided in the illustrated embodiments of the lawn care appliance 11. The lane recognition device 132 comprises a lane detection unit 134-1, 134-2 on at least one of the sides, preferably on both sides of the lawn care appliance 11, each of which comprises at least one camera 136. The cameras 136 capture an image of an area to the side of the lawn care appliance 11 and in front of the implement 12, which in this case is in front of the drive shaft 20. Further, the lane recognition device 132 comprises, for example as part of the controller 102 or as part of the respective lane recognition units 134-1, an image processing unit 138 for image processing of the images captured by the respective camera 136 and for pattern recognition in these images. Corresponding optical devices having cameras 136 and image processing units 138, each capable of recognizing predetermined patterns, are available on the market and are described and shown, for example, in literature [8] and [9].

In embodiments not shown in detail, the lane recognition device 132 may further include at least one light source for illuminating the area to be captured by the camera. The image quality of the camera images can thus be enhanced, for example, in ambient conditions with low light intensity, by the use of additional light sources mounted on the lawn care appliance 11.

According to the attached drawing figures, the at least one image processing unit 138 is configured to recognize different patterns depending on the mode of operation, so as to recognize or discern the boundary of a previously treated first lane 140 when driving along an adjacent second lane 142 and either assist the operator to drive along the second lane 142 immediately adjacent to the first lane 140 or, in an automatic mode, issue corresponding commands to the steering device 120 to automatically drive along the second lane 142 so that the same is immediately adjacent the first lane 140.

The lawn care appliance 11 can be operated in different modes, depending on which a different ground image can be selected for pattern recognition by the image processing unit 138.

In the first mode of operation shown in FIG. 1, the subsoiling device 38 is operated with solid tines as tines 42, and the lawn is relatively short. Accordingly, a hole pattern 144 having a defined hole spacing is optically recognizable by the cameras 136 and can be detected by the image processing unit 138 in a first setting. The lateral boundary of the hole pattern 144 indicates the boundary 156 of the first lane 140, along which the lawn care appliance 11 is to travel in order to process the second lane 142 immediately thereafter.

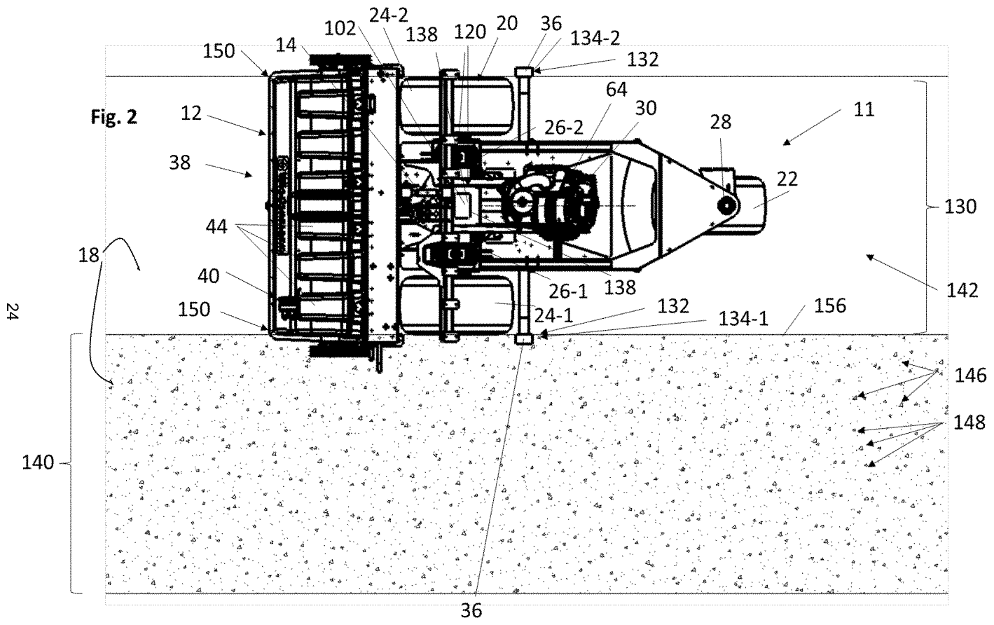

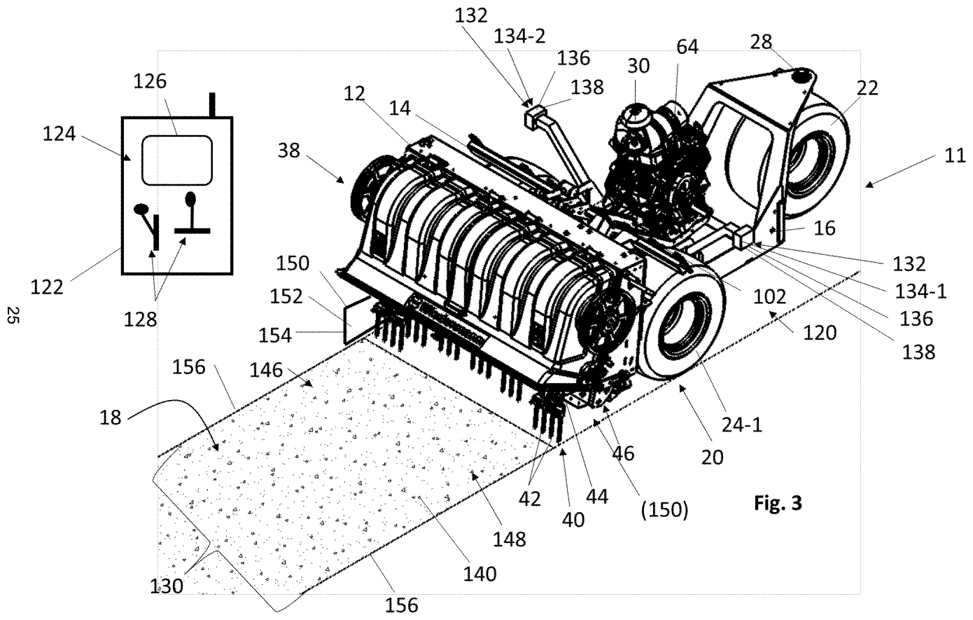

In the mode of operation shown in FIGS. 2 and 3, hollow spoons are used as tines 42. The corresponding hollow tines 42, which are formed with a lower opening and an upper ejection, thus remove soil material 146 and deposit it on the ground 18 in the form of soil material cones 148. With corresponding guide elements 150, such as a coulter 152, here formed as a lateral swath plate 154 (only one shown on the side, the other corresponding one on the other side omitted for illustration purposes) limits the dropping area and ensures that the soil material cones 148 are only on the first lane 140, so that a visually recognizable transition is produced at the boundary 156 of the first lane 140. In this second mode of operation, the image processing 138 is configured to recognize the deposition pattern of the soil material cones 148 so as to determine the boundary 156 of the first lane 140.

In a third mode of operation, not shown in detail, the lawn is higher, so that the hole pattern 144 is not optimally optically recognizable.

The support rollers 46 are arranged to extend exactly to the boundary of the lane width 130. When traveling across the ground, the lawn is pressed down by means of the support rollers 46 (or additionally or alternatively by other means, e.g. by means of the drive wheels 24-1, 24-2), so that the boundary 156 between the pressed-down lawn and the lawn still standing up is visually discernible. In this third mode of operation, a corresponding ground image is also set as a pattern to be recognized in the image processing unit 138.

The image processing unit 138 is designed as an electronic unit with corresponding control programs and memories, in which the respective ground images are set as patterns to be recognized and which can be selected at the operator interface 124 in accordance with the selected operating mode of the lawn care appliance 11.

The one lane 140 previously treated is thus used as a reference lane for traveling the subsequent lane 142. The boundary 156 of the respective reference lane 140 is recognized.

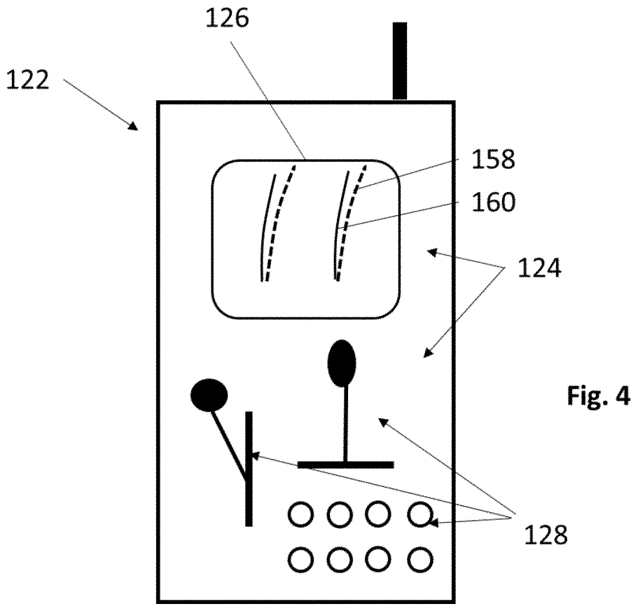

In some embodiments, in a manual mode, a target lane 158 is displayed on the display 126, as shown in FIG. 4, based on the boundary 156 of the reference lane thus detected, and a current actual lane 160 is displayed based on the current setting of the steering device 120. The operator can thus control the steering device 120 by means of the actuating elements 128 in such a way that the reference lane 158 and the actual lane 160 coincide, in order to then move the implement 12 over the next area 142 of the ground 18 adjacent to the already treated area 140 of the ground.

In an automatic mode, the steering device 120 is controlled by appropriate control programs in the controller 102 in response to the output of the lane recognition device 132.

The hardware of the optical lane recognition devices 132 is available at very low cost compared to other possible positioning units. The lane recognition device 132 enormously facilitates the operation of the lawn care appliance 11 and enables a very uniform treatment of an even larger area, even in shaded areas such as in soccer stadiums, by precisely traveling lanes 140, 142 that are exactly adjacent to each other. The subsoiling device 38 is removably hinged to the implement linkage 14 and can also be replaced by another implement 12, for example a mowing deck, in order to perform other work as well.

### LIST OF REFERENCE SIGNS

11 lawn care appliance
12 implement
14 implement linkage
16 chassis
18 ground
20 drive shaft
22 swivel wheel
24-1 first drive wheel
24-2 second drive wheel
26-1 first drive motor
26-2 second drive motor
28 swivel axis
30 drive unit
38 subsoiling device
40 piercing tools
42 tine
44 support arm
46 support roller
64 combustion engine
102 controller
120 steering device
122 remote control
124 operator interface
126 display
128 actuating element
130 lane width
132 lane recognition unit
134-1 lane recognition unit
134-2 lane recognition unit
136 camera
138 image processing unit
140 first lane
142 second lane
144 hole pattern
146 soil material
148 soil material cone
150 guiding element
152 coulter
154 coulter plate
156 boundary
158 target lane
160 actual lane

1. A self-propelled lawn care appliance for aerating or subsoiling the ground beneath a turf, comprising:
a chassis having at least one drive shaft and a steering device;
an implement comprising a row of piercing tools that extends over a lane width, the piercing tools having tines movable up and down for piercing the ground for subsoiling; and
an optical lane recognition device comprising at least one camera for capturing an image of an area of the ground laterally of or laterally and at least partly ahead of the implement with respect to the direction of travel, and an image processing unit for image processing of and pattern recognition in images captured by the at least one camera,
a) wherein in a first mode of operation of the lawn care appliance, the working implement is configured to produce a hole pattern with a predefined lane width when travelling across the ground during the use of the working implement, and the lane recognition device is configured to recognize the hole pattern of an area of the ground previously treated by the lawn care appliance and, based thereon, a boundary of a previously treated lane, and/or
b) wherein in a second mode of operation of the lawn care appliance, the implement is configured to remove soil material from the ground and deposit it on the predefined lane width with a defined boundary, wherein the lane recognition device is configured to recognize the defined boundary of the deposited soil material of a ground area previously treated by the lawn care appliance and, based thereon, the boundary of a previously treated lane.

2. The lawn care appliance according to claim 1, wherein in a third mode of operation, the lawn care appliance is configured to produce, by means of a supporting or engaging element engaging the ground, a ground pattern having a defined boundary of the lane width, the lane recognition device being configured to detect, on the basis of the defined boundary of the ground pattern, a previously treated lane.

3. The lawn care appliance according to claim 1, wherein the lawn care appliance is remotely controllable and a user interface is formed on a remote control of the lawn care appliance.

4. The lawn care appliance according to claim 1, further comprising:
a controller configured to control the drive shaft and the steering device,
wherein in an automatic mode, the controller is configured to steer the lawn care appliance, based on the output of the lane recognition device, in such a way that the current lane of the implement extends immediately adjacent to the previously treated lane.

5. The lawn care appliance according to claim 1, further comprising:
an operator interface comprising a display,
wherein information on a target lane determined from data of the lane recognition device and information on a current actual lane are indicated on the display.

6. The lawn care appliance according to claim 1, wherein the camera of the lane recognition device is arranged laterally on the lawn care appliance outside the lane width.

7. The lawn care appliance according to claim 1, wherein the lane recognition device comprises a camera on each of the two sides.

8. The lawn care appliance according to claim 1, wherein the drive shaft has two differently controllable and drivable drive wheels and the chassis further comprises at least one freely rotatable swivel wheel arranged at a distance from the drive shaft in the direction of travel.

9. The lawn care appliance according to claim 1, wherein in the first mode of operation, solid tines are provided on the piercing tools and/or, in the second mode of operation, hollow tines are provided on the piercing tools.

10. The lawn care appliance according to claim 1, wherein at least one mechanical guiding and/or marking element is provided for producing the visually recognizable defined boundary of the previously treated lane.

11. The lawn care appliance according to claim 10, wherein the at least one mechanical guiding and/or marking element comprises a swath board or a swath plate or a tracking disc for engaging the ground.

12. A lawn care method for soil aeration or subsoiling of the ground below a turf, comprising:
moving a lawn care appliance along a first lane across the ground and treating the ground by alternately inserting and extracting a series of piercing tools with tines of the lawn care appliance while pivoting the inserted piercing tools in the ground, thereby producing a visually recognizable pattern to determine a boundary of the first lane; and
moving the lawn care appliance along a second lane adjacent to and in parallel with the first lane to correspondingly treat the ground along the second lane, wherein the first lane is detected by optically detecting the recognizable pattern to recognize the boundary of the first lane and steer the lawn care appliance in response to the detected boundary.

13. The lawn care method according to claim 12, further comprising:
remote controlling the lawn care appliance by an operator spaced from the lawn care appliance at a distance from the lawn care appliance.

14. The lawn care method according to claim 12, wherein the pattern recognition comprises:
a) detecting a pattern of holes on the ground produced by the piercing tools; and/or
b) producing a defined optically detectable boundary of the first lane by at least one mechanical supporting, guiding or marking element and optically detecting the boundary of the first lane.

15. The lawn care method according to claim 14, wherein step b) comprises:
depositing soil material removed from the ground during the insertion and extraction of the piercing tools and arranging the deposited soil material on the first lane up to the defined boundary.
